(19) United States
(12) Patent Application Publication
(10) Pub. No.: US 2025/0053196 A1
(43) Pub. Date: Feb. 13, 2025

(54) DOCK WITH ISOLATED DOCK CONNECTOR AND METHODS OF MAKING AND USING

(71) Applicant: National Products, Inc., Seattle, WA (US)

(72) Inventor: Jeffrey D. Carnevali, Seattle, WA (US)

(21) Appl. No.: 18/233,218

(22) Filed: Aug. 11, 2023

(51) Int. Cl. G06F 1/16

(52) U.S. Cl. CPC G06F 1/1632

(57) ABSTRACT

A dock for an electronic device includes a base configured to fit over at least a portion of a back surface of the electronic device; a tray extending from the base for receiving one side of the electronic device; and a dock connector arrangement that includes a dock connector formed of a first rigid or hard plastic material, a plurality of contacts extending out of, or disposed on, the dock connector, an elastomeric sleeve molded around at least a perimeter of the dock connector, and a contact box, wherein at least a portion of the contact box is molded around at least a perimeter of the elastomeric sleeve, wherein at least the portion of the contact box is formed of a second rigid or hard plastic material, wherein the contact box is coupled to, or part of, the base or the tray.

### FIELD

The present invention is directed to a dock for an electronic device. The present invention is also directed to a dock with an isolated dock connector and methods of making and using the dock.

### BACKGROUND

Mobile devices, such as smartphones, cellular or mobile phones, tablets, personal data assistants, and other portable devices, are now ubiquitous. Docks can be used to protect the mobile device, to couple the mobile device to a source of power or data, or to mount the mobile device onto a surface or object or any combination thereof.

### BRIEF SUMMARY

One embodiment is a dock for an electronic device. The dock includes a base configured to fit over at least a portion of a back surface of the electronic device; a tray extending from the base for receiving one side of the electronic device; and a dock connector arrangement that includes a dock connector formed of a first rigid plastic material, a plurality of contacts extending out of, or disposed on, the dock connector, an elastomeric sleeve molded around at least a perimeter of the dock connector, and a contact box, wherein at least a portion of the contact box is molded around at least a perimeter of the elastomeric sleeve, wherein at least the portion of the contact box is formed of a second rigid plastic material, wherein the contact box is coupled to, or part of, the base or the tray.

Another embodiment is a dock for an electronic device. The dock includes a base configured to fit over at least a portion of a back surface of the electronic device; a tray extending from the base for receiving one side of the electronic device; and a dock connector arrangement that includes a dock connector formed of a first hard plastic material, a plurality of contacts extending out of, or disposed on, the dock connector, a sleeve formed of a soft plastic material and disposed around at least a perimeter of the dock connector, and a contact box, wherein at least a portion of the contact box is disposed around at least a perimeter of the sleeve, wherein at least the portion of the contact box is formed of a second hard plastic material, wherein the contact box is coupled to, or part of, the base or the tray.

A further embodiment is a method of making a dock for an electronic device. The method includes molding an elastomeric sleeve around at least a perimeter of a dock connector, wherein the dock connector is formed of a first rigid plastic material; and molding at least a portion of a contact box around at least a perimeter of the elastomeric sleeve, wherein at least the portion of the contact box is formed of a second rigid plastic material.

In at least some embodiments, either the first rigid or hard plastic material of the dock connector or the second rigid or hard plastic material of the portion of the contact box has a hardness of at least 70 on the Shore D scale or at least 100 on the Rockwell scale. In at least some embodiments, either the first rigid or hard plastic material of the dock connector or the second rigid plastic material of the portion of the contact box has a hardness in a range of 70 to 80 on a Shore D scale or in a range of 100 to 120 on a Rockwell R scale.

In at least some embodiments, the elastomeric sleeve includes an elastomeric material having a hardness of no more than 98 on a Shore A scale. In at least some embodiments, the soft plastic material has a hardness of no more than 98 on a Shore A scale.

In at least some embodiments, at least one of the first rigid or hard plastic material or the second rigid or hard plastic material includes acrylonitrile butadiene styrene (ABS), polycarbonate (PC), or a combination thereof. In at least some embodiments, the elastomeric sleeve includes an elastomeric material selected from thermoplastic rubber (TPR), thermoplastic elastomer (TPE), thermoplastic urethane (TPU), or any combination thereof. In at least some embodiments, the soft plastic material includes thermoplastic rubber (TPR), thermoplastic elastomer (TPE), thermoplastic urethane (TPU), or any combination thereof.

In at least some embodiments, the dock connector has a plurality of openings, wherein the contacts extend through the openings of the dock connector. In at least some embodiments, the first rigid material and the second rigid material are the same.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective top view of one embodiment of a dock with an electronic device disposed therein, according to the invention;

FIG. 1B is a schematic perspective top view of the dock of FIG. 1A without the electronic device, according to the invention;

FIG. 1C is a schematic perspective top view of the dock of FIG. 1A without the electronic device and from an angle to show two dock connector arrangements, according to the invention;

FIG. 2A is a schematic perspective front view of one embodiment of a dock connector arrangement with a cord attached thereto, according to the invention;

FIG. 2B is a schematic perspective front view of another embodiment of a dock connector arrangement with a cord attached thereto, according to the invention;

FIG. 2C is a schematic perspective front view of a dock connector of the dock connector arrangement of FIG. 2A, according to the invention;

FIG. 2D is a schematic perspective front view of an elastomeric sleeve of the dock connector arrangement of FIG. 2A, according to the invention;

FIG. 2E is a schematic perspective front view of a combination of the dock connector of FIG. 2C and the elastomeric sleeve of FIG. 2D, according to the invention;

FIG. 3A is a schematic perspective front side view of a portion of the dock connector arrangement of FIG. 2A disposed in a contact box, according to the invention; and

FIG. 3B is a schematic perspective top view of the dock of FIG. 1A without the electronic device with covers of two contact boxes removed, according to the invention.

### DETAILED DESCRIPTION

The present invention is directed to a dock for an electronic device. The present invention is also directed to a dock with an isolated dock connector and methods of making and using the dock.

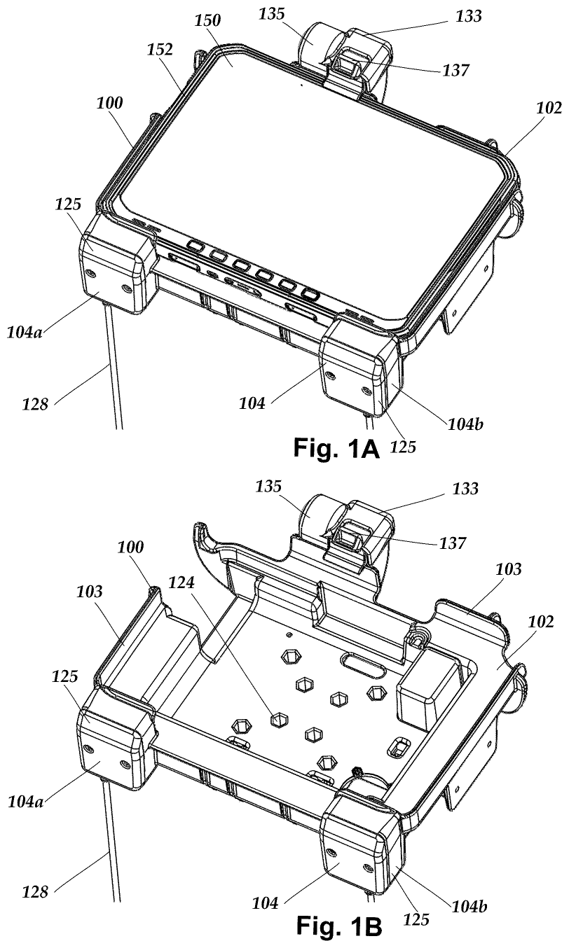

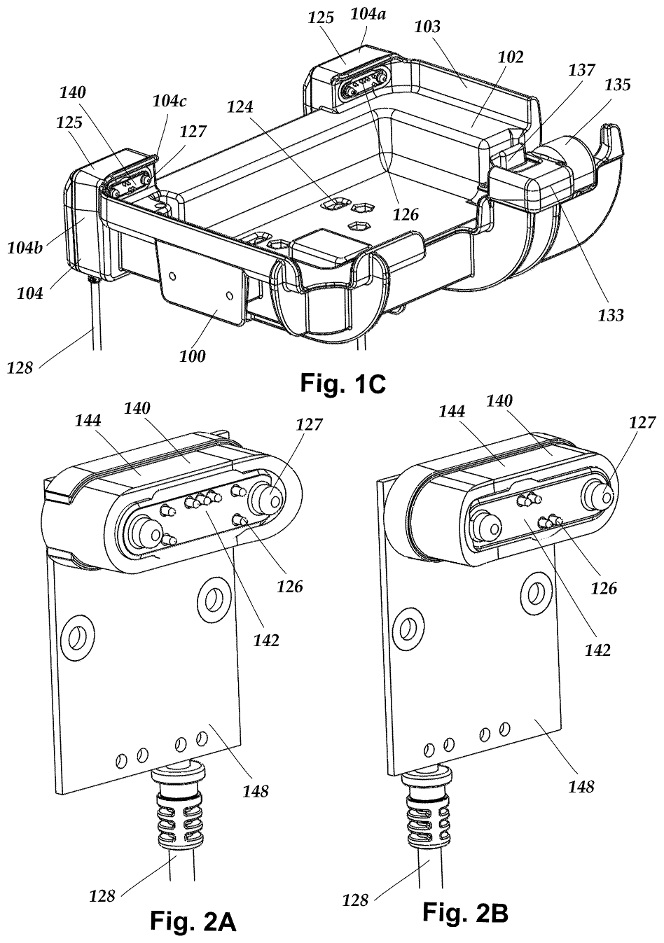

FIGS. 1A, 1B, and 1C illustrate one embodiment of a dock 100. The dock 100 can receive an electronic device 150 that is optionally disposed in a case 152. The electronic device 150 can be any suitable portable device such as, but not limited to, a mobile phone (e.g., a cellphone or a smartphone), a tablet, a personal data assistant, a laptop computer, or the like. In at least some embodiments, the dock 100 is designed, sized, or arranged for one or more specific types or models of electronic device(s) 150.

The dock 100 includes a base 102 that is arranged to be disposed beneath the electronic device 150 and a tray 104 extending from the base 102 for receiving one side of the case 152 and electronic device 150. In the illustrated embodiment, the tray is formed in two parts 104a, 104b. In at least some embodiments, the tray 104 includes one or more portions 104c (FIG. 1C) that extend over a part of the front surface of the electronic device 150 to retain the electronic device in the dock 100. In at least some embodiments, the dock 100 may also include one or more retaining sidewalls 103 that fit around one or more sides of the electronic device 150, for example, to facilitate protection, alignment, or retention of the electronic device in the dock. In at least some embodiments, the base 102, tray, 104, or sidewall 103 can include one or more grooves, ridges, tabs, or tab-receiving openings to facilitate retention of the electronic device 150 (optionally with the case 152) in the dock 100.

In at least some embodiments, the dock 100 can include a locking mechanism 133 with a lock 135 and a sliding tab 137 that can fit over a portion of the front surface of the electronic device 150 to hold the electronic device in the dock. In at least some other embodiments, the dock 100 can include one or more attachment arms 106 extending from the base for retaining the electronic device 150 in the dock. Examples of other docks with attachment arms can be found in U.S. patents applications Ser. Nos. 16/298,952 and 17/174, 152, both of which are incorporated herein by reference in their entireties.

In at least some embodiments, one or more accessories are attached or attachable to the dock 100. Example of such accessories include, but are not limited to, a mount, a fan, or the like or any combination thereof. In at least some embodiments, the dock 100 includes a mounting arrangement (not shown) having multiple attachment apertures 124 (FIG. 1B) for receiving a fastener to attach a mount to the mounting arrangement. The mount can be any suitable mount that can be attached to a mounting device. Non-limiting examples of mounts, mounting arrangements, and mounting devices can be found at, for example, U.S. Pat. Nos. 5,845,885; 6,561,476; 7,320,50; 7,997,554; 8,454,178; 8,505,861; 9,831,904; RE42,060; RE42,581; and RE43,806 and U.S. patents applications Ser. Nos. 16/298,952 and 17/174,152, all of which are incorporated herein by reference in their entireties.

The dock 100 also includes one or more contact boxes 125 attached to, or forming part of, the tray 104 or the base 102 (or both) of the dock. As illustrated in FIG. 1C, one or more contacts 126 and one or more guide pins 127 (e.g., location pins) extend out of the contact box 125. The contacts 126 are configured to couple to contacts on the case 152 or electronic device 150. The contacts 126 can be suitable for delivering power, data, or the like to the electronic device 150. The dock 100 can include any number of contacts 126 such as, for example, one, two, four, six, eight, ten, twelve, sixteen or more contacts or any other suitable number of contacts. Any type of contact 126 can be used including, but not limited to, stationary contacts, pogo pins, other movable contacts, pins, contact pads, or the like or any combination thereof. For a dock 100 having multiple contact boxes 125, the arrangement of the contacts 126 associated with each contact box can be the same or can be different (for example, see, FIG. 1C).

In at least some embodiments, the guide pins 127 facilitate the alignment of electronic device 150 in the dock 100 or alignment of the contacts on the electronic device 150 or case 152 with the contacts 126 of the dock 100. The dock 100 can include any number of guide pins 127 such as, for example, one, two, three, four, or more guide pins. For a dock 100 having multiple contact boxes 125, one, two, three, four, or more guide pins 127 can be associated with each contact box.

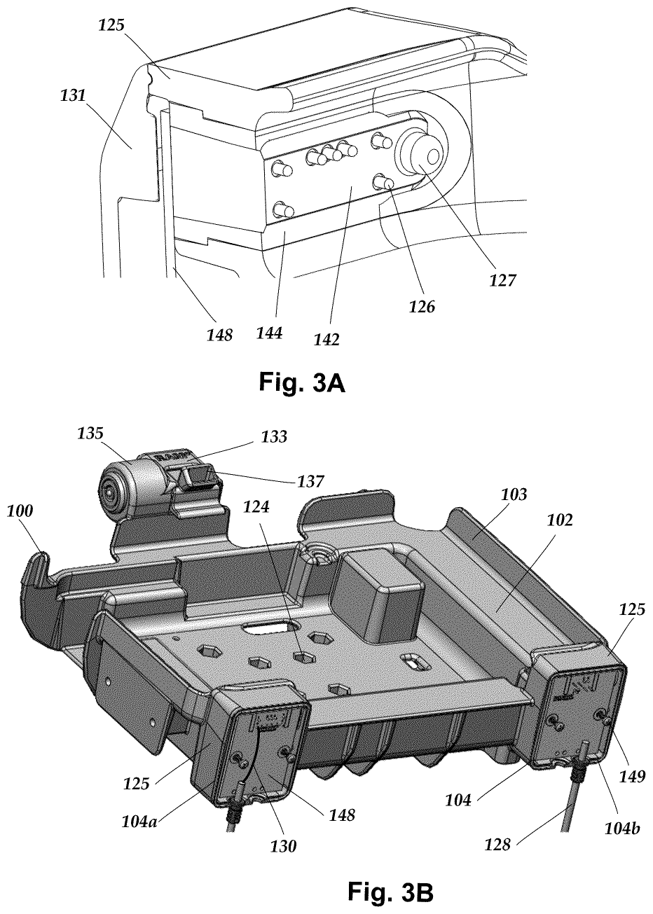

The contacts 126 are coupled to wires 130 (see, FIG. 3B-only one wire is illustrated for clarity purposes) or other conductors that are carried, in part, by at least one cord 128 that extends from the contact box 125 of the dock 100. In the illustrated embodiment, there are two contact boxes 125 that each have a cord 128 extending therefrom. In at least some embodiments, any cord 128 can have a connector at the other end. In at least some embodiments, any cord 128 can be hardwired, or hardwireable, into another device that can provide the power, data, or the like. In at least some embodiments, the cord(s) 128 may be used to tether the dock 100 to an external structure to hinder or prevent removal of the dock from the external structure (e.g., a vehicle, platform, or the like). Any other mechanism can be used to tether or fix the dock 100 to an external structure.

In at least some instances, when the contact box(es) 125, tray 104, and base 102 are molded, small variations in the dimensions of these elements are observed among the manufactured docks 100. Moreover, the dock 100 can experience minor changes in shape over time. These effects can result in a degree of misalignment between the contacts 126 of the dock 100 and the contacts of the electronic device 150. In addition, the electronic device 150 may exhibit some movement within the dock 100 due to vibration, shocks, or the like. For example, an electronic device 150 in a dock 100 secured to a vehicle can experience vibration or shocks while the vehicle is in motion. In at least some instances, the vibration or shock can result in breaking connections between the contacts 126 of the dock 100 and the contacts of the electronic device 150.

To address, for example, misalignment, vibration, or shock, it can be useful to allow the guide pins 127 or contacts 126 to move relative to base 102 and other portions of the dock 100. This allows the guide pins 127 or contacts 126 to float relative to the base 102 and other portions of the dock 100. In at least some embodiments, insertion of the electronic device 150 into the dock 100 and engagement of the guide pins 127 by the electronic device can move the contacts 126 relative to the base 102 and other portions of the dock 100 to provide good alignment between the contacts 126 of the dock and the contacts of the electronic device. In at least some embodiments, vibration or other movement of the electronic device 150 relative to the base 102 or other portions of the dock 100 can result in the electronic device pushing against the guide pins 127. Allowing the guide pins 127 to float with the electronic device 150 can facilitate maintenance of contact between the contacts of the dock and the contacts of the electronic device.

A dock connector arrangement 140 is disposed within the contact box 125 of the dock 100 and includes a dock connector 142 and an elastomeric sleeve 144 disposed around at least a perimeter of the dock connector 142 and in contact with the contact box 125. At least one face of the dock connector 142 is exposed so that the contacts 126 and guide pins 127 are accessible to the electronic device 150 or case 151. The dock connector 142 includes the contacts 126 disposed thereon or has openings from which the contacts 126 (for example, pogo pins) extend. The guide pins 127 can extend through openings in the dock connector 142 or are attached to the dock connector.

The elastomeric sleeve 144 acts as an interface between the dock connector 142 and the contact box 125. The flexible or compressible nature of the elastomeric sleeve 144 allows the dock connector 142 and the associated guide pins 127 and contacts 126 to move relative to the contact box 125, the base 102, and other portions of the dock 100.

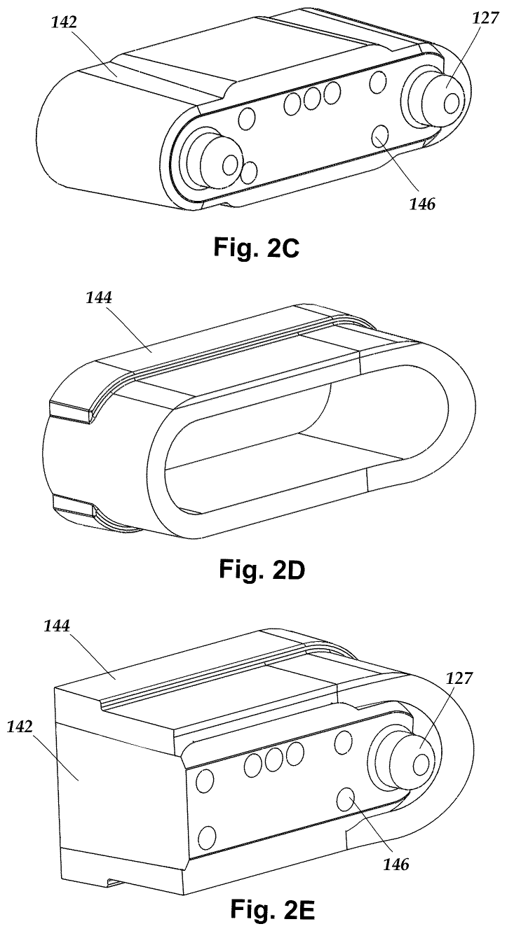

FIGS. 2A and 2B illustrate two different embodiments of a dock connector arrangement 140. FIG. 2C illustrates one embodiment of the dock connector 142 with guide pins 127 and openings 146 for the contacts. FIG. 2D illustrates one embodiment of the elastomeric sleeve 144. FIGS. 2E illustrates the elastomeric sleeve 144 disposed around the dock connector 142. FIGS. 2A and 2B illustrate two embodiments of the dock connector arrangement 140 illustrating the dock connector 142, elastomeric sleeve 144, guide pins 127, contacts 126, and substrate 148 (for example, a printed circuit board (PCB)), as well as the cord 128 attached to the dock connector arrangement. In at least some embodiments, contact 126, such as pogo pins, are attached to the substrate 148. In at least some embodiments, the substrate 148 floats or moves with the contacts 126 and dock connector 142. In at least some embodiments, conductors are printed or otherwise disposed on the substrate 148 for electrically coupling the contacts 126 to the wires 130 of the cord 128.

FIGS. 2A and 2B illustrate two different arrangements of the contacts 126. For example, in at least some embodiments, one dock connector arrangement 140 may be coupled to a power source and another dock connector arrangement coupled to a data source. In at least some embodiments, the different contact arrangements arise from the different sources to which the separated dock connector arrangements are coupled.

The dock connector 142 and the contact box 125 are made using a rigid or hard plastic, such as, for example, acrylonitrile butadiene styrene (ABS), polycarbonate (PC), nylon, or the like or any combination thereof (e.g., ABS/PC). The material of the dock connector 142 and the contact box 125 can be the same or can be different. In at least some embodiments, the material(s) of the dock connector 142 and the contact box 125 (which can be the same or can be different) have a hardness of at least 70 on the Shore D scale or at least 100 on the Rockwell scale. In at least some embodiments, the material(s) of the dock connector 142 and the contact box 125 have a hardness in a range of 70 to 80 on the Shore D scale or in a range of 100 to 120 on the Rockwell R scale.

The elastomeric sleeve 144 is made of any suitable elastomeric or soft material, such as, for example, thermoplastic rubber (TPR), thermoplastic elastomer (TPE), thermoplastic urethane (TPU), or the like or any combination thereof. In at least some embodiments, the material(s) of the elastomeric sleeve 144 have a hardness of no more than 98 on the Shore A scale. In at least some embodiments, the material of the elastomeric sleeve 144 has a hardness in a range of 35 to 98 on the Shore A scale.

One embodiment of making the dock 100 includes molding the dock connector 142 using a rigid or hard plastic, such as, for example, ABS/PC. The elastomeric sleeve 144, formed using, for example, a TPR, TPU, or TPE elastomeric or soft material, is molded over at least a perimeter of the dock connector 142 leaving at least one face of the dock connector exposed. Materials, such as TPR/TPE/TPU elastomeric or soft materials, when molded over ABS/PC or the like, have good adhesion, and bonds, to ABS/PC or the like.

Then, at least a portion of the contact box 125 (and, optionally, the base 102 and tray 104) is molded around at least a perimeter of the elastomeric sleeve 144 using a rigid or hard plastic, such as ABS/PC, as illustrated in FIG. 3A. Although the mold temperature and flow temperature for molding of ABS/PC or the like is substantially higher than the mold temperature and flow temperature for molding TPR/TPE/TPU, it is surprisingly found that the molding of ABS/PC or the like to an insert made of TPR/TPE/TPU elastomeric material can be performed and also bonds these two materials. In at least some embodiments, the molding of the elastomeric sleeve 144 to the dock connector 142 and then molding a portion of the contact box 125 to the elastomeric sleeve 144 can produce a water-proof or water-resistant seal. In at least some embodiments, the contact box 125 is water-proof or water-resistant. In at least some embodiments, this arrangement is anti-vibration or vibration-absorbing.

In at least some embodiments, the contact box 125 includes a cover 131, as illustrated in FIG. 3A, that can be removed, as illustrated in FIG. 3B. The cover 131 can be attached to the contact box 125 (and, optionally, the substrate 148) using one or more fasteners 149, such as screws, bolts, or the like or any other suitable fastener. In at least some embodiments, the cover 131 may be molded or otherwise manufactured separately from the portion of the contact box 125 that is molded around the elastomeric sleeve 144.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A dock for an electronic device, the dock comprising:
a base configured to fit over at least a portion of a back surface of the electronic device;
a tray extending from the base for receiving one side of the electronic device; and
a dock connector arrangement comprising
a dock connector formed of a first rigid plastic material,
a plurality of contacts extending out of, or disposed on, the dock connector,
an elastomeric sleeve molded around at least a perimeter of the dock connector, and
a contact box, wherein at least a portion of the contact box is molded around at least a perimeter of the elastomeric sleeve, wherein at least the portion of the contact box is formed of a second rigid plastic material, wherein the contact box is coupled to, or part of, the base or the tray.

2. The dock of claim 1, wherein the second rigid plastic material of the portion of the contact box has a hardness of at least 70 on the Shore D scale or at least 100 on the Rockwell scale.

3. The dock of claim 1, wherein the second rigid plastic material of the portion of the contact box has a hardness in a range of 70 to 80 on a Shore D scale or in a range of 100 to 120 on a Rockwell R scale.

4. The dock of claim 1, wherein the elastomeric sleeve comprises an elastomeric material having a hardness of no more than 98 on a Shore A scale.

5. The dock of claim 1, wherein at least one of the first rigid plastic material or the second rigid plastic material comprises acrylonitrile butadiene styrene (ABS), polycarbonate (PC), or a combination thereof.

6. The dock of claim 5, wherein the elastomeric sleeve comprises an elastomeric material selected from thermoplastic rubber (TPR), thermoplastic elastomer (TPE), thermoplastic urethane (TPU), or any combination thereof.

7. The dock of claim 1, wherein the dock connector has a plurality of openings, wherein the contacts extend through the openings of the dock connector.

8. The dock of claim 1, wherein the first rigid material and the second rigid material are the same.

9. A method of making a dock for an electronic device, the method comprising:
molding an elastomeric sleeve around at least a perimeter of a dock connector, wherein the dock connector is formed of a first rigid plastic material; and
molding at least a portion of a contact box around at least a perimeter of the elastomeric sleeve, wherein at least the portion of the contact box is formed of a second rigid plastic material.

10. The method of claim 9, wherein the second rigid plastic material of the portion of the contact box has a hardness of at least 70 on the Shore D scale or at least 100 on the Rockwell scale.

11. The method of claim 9, wherein the second rigid plastic material of the portion of the contact box has a hardness in a range of 70 to 80 on a Shore D scale or in a range of 100 to 120 on a Rockwell R scale.

12. The method of claim 9, wherein the elastomeric sleeve comprises an elastomeric material having a hardness of no more than 98 on a Shore A scale.

13. The method of claim 9, wherein at least one of the first rigid plastic material or the second rigid plastic material comprises acrylonitrile butadiene styrene (ABS), polycarbonate (PC), or a combination thereof.

14. The method of claim 13, wherein the elastomeric sleeve comprises an elastomeric material selected from thermoplastic rubber (TPR), thermoplastic elastomer (TPE), thermoplastic urethane (TPU), or any combination thereof.

15. A dock for an electronic device, the dock comprising:
a base configured to fit over at least a portion of a back surface of the electronic device;
a tray extending from the base for receiving one side of the electronic device; and
a dock connector arrangement comprising
a dock connector formed of a first hard plastic material,
a plurality of contacts extending out of, or disposed on, the dock connector,
a sleeve formed of a soft plastic material and disposed around at least a perimeter of the dock connector, and
a contact box, wherein at least a portion of the contact box is disposed around at least a perimeter of the sleeve, wherein at least the portion of the contact box is formed of a second hard plastic material, wherein the contact box is coupled to, or part of, the base or the tray.

16. The dock of claim 15, wherein the second hard plastic material of the portion of the contact box has a hardness of at least 70 on the Shore D scale or at least 100 on the Rockwell R scale.

17. The dock of claim 15, wherein the second hard plastic material of the portion of the contact box has a hardness in a range of 70 to 80 on a Shore D scale or in a range of 100 to 120 on a Rockwell R scale.

18. The dock of claim 15, wherein the soft plastic material has a hardness of no more than 98 on a Shore A scale.

19. The dock of claim 15, wherein at least one of the first hard plastic material or the second hard plastic material comprises acrylonitrile butadiene styrene (ABS), polycarbonate (PC), nylon, or a combination thereof.

20. The dock of claim 15, wherein the soft plastic material comprises thermoplastic rubber (TPR), thermoplastic elastomer (TPE), thermoplastic urethane (TPU), or any combination thereof.
